(19) United States
(12) Patent Application Publication
(10) Pub. No.: US 2006/0230671 A1
(43) Pub. Date: Oct. 19, 2006

(54) Remote operated varmint control device

(75) Inventors: Bus Hudson, Boise, ID (US); Drex Shira, Adrian, OR (US)

Correspondence Address: DEREK H. MAUGHAN;DYKAS, SHAVER & NIPPER, LLP, PO BOX 877, BOISE, ID, 83701-0877, US

(73) Assignee: Farm and Ranch Manufacturing, Adrian, OR (US)

(21) Appl. No.: 11/179,688

(22) Filed: Jul. 11, 2005

Related U.S. Application Data
(60) Provisional application No. 60/671,787, filed on Apr. 15, 2005.

(51) Int. Cl. A01M 15/00; A01M 17/00

(52) U.S. Cl. 43/124

(57) ABSTRACT

A device and a method for killing burrowing animals through the remote detonation of an exploding gas within the burrow of an animal. The device comprising a source of flammable gas connected to discharge tube which is operatively connected through a charging valve to a control box and a head. The head is made of a durable material and having a generally sloping face portion. The head configured for placement within an opening and further configured to hold materials within the burrow. The device can be remotely operated so as to allow the device to be detonated from a remote location thus increasing the safety of the device to a user.

### PRIORITY

This application is a non-provisional utility patent application which claims priority from an earlier filed provisional patent application entitled REMOTE OPERATED VARMINT CONTROL DEVICE filed by Bus Hudson, et al., on Apr. 15, 2005, application serial number 60/671,787, the disclosure of this provisional application is herein incorporated by reference.

### BACKGROUND OF THE INVENTION

1. Field of the Invention

The present invention generally relates to rodent extermination devices, and more specifically for a device for destroying and removing burrowing rodents and other animals.

2. Background of the Invention

In many parts of the country rodents and other animals that live in burrows are considered a pest and a nuisance. These animals create problems not only because of the damage that they cause to plants such as food crops, shade trees and landscaping but also to other animals, property, waterways and other valuable items. These burrowing animals are often considered pests because the underground passageways or burrows that they create cause damage in a variety of ways.

First, these rodents and the burrows that they create cause damage to crops and plants by eating the crops and plants themselves. This is particularly true when the plants are small, and the leaves and stems are green and relatively easy for these animals to consume. Secondly, these rodents damage plants because the burrowing action of these rodents causes underground damage to the roots and support structures of the plants themselves. The destruction of these roots and support structures then causes the plants to wither and die because these items cannot extract sufficient water and nutrients through their root structure. In addition, these burrows may impede or interfere with the irrigation systems which would ordinarily be utilized to transport water from a source such as a river or a reservoir to another location to water these plants and allow them to grow. This interference with the irrigation system can also cause flooding in other locations with its accompanying destruction to property and lives.

In addition to these problems, the burrows of these rodents can cause damage to livestock and humans as the surface above these burrows can break when sufficient force is applied. This breaking of the ground surface can cause injury to the humans and/or animals that walk upon or run over these burrows. This damage can result in injury and death to the animal and in some cases to the humans that may be riding upon these animals. In addition to these costs, these burrows can cause damage to mechanical vehicles such as tractors, wheel-lines and other types of farming machinery which must pass over these burrows and sustain the jarring forces which accompany this use.

Because of the significant damage caused by these animals, a variety of types of extermination devices have been attempted to rid various locations of the presence of these animals and to prevent the occurrence of the burrows. In some areas, trapping has been approved and in some cases even encouraged by local government agencies for the capture and destruction of these animals. In addition, other methods such as poisonings have also been utilized. However, there are a variety of problems with these types of methods and devices.

The use of poison is not desirable because of the damaging effects that poison has upon both other animals that may eat the poison accidentally, as well as the various predators who would eat the dead rodents for which the poison is intended. Trapping can be both time consuming and expensive as these traps must be purchased, set and regularly checked. In some instances mechanical traps can be unintentionally triggered, thus rendering such traps inoperable and unreliable.

Because of these inefficiencies and problems, a variety of other ways for exterminating rodents have been invented. One of the methods is the use of a gas-fired apparatus which is utilized to explode the burrows in which these animals live. Examples of such methods and their associated systems are described in U.S. Pat. No. 4,005,976 to Rombach, et al., as well as U.S. Pat. No. 6,171,098 to Meyer, et al. However, a variety of drawbacks exist to the use of such devices.

Both the Rombach and the Meyer device describe a device made up of a wand or a tube which is attached to a pair of gas lines that bring gas into a hole or burrow. After these gasses have been injected into the hole, the gas within the hole is ignited by the person holding the wand with the intent that the concussion from this explosion be sufficient so as to kill the animals within the burrow and prevent any further burrowing by these animals.

The inherent danger in this type of methodology lies in the proximity in which the user must be to the hole when the device is fired. This in turn limits the quantity of gas that can be placed into the hole as well as the size of the rodents and burrowing animals that can be exterminated with this type of device. In addition, this methodology, because it requires that the operator stand next to the hole where the wand is inserted, places the user at risk of damage from flying debris such as rocks and dirt as well as the backlash of exploding material when the gas in the hole is ignited. In addition to these problems, the use of these devices also causes damage to the legs or other body parts of a user because of the potential kickback which may occur when the device is activated. This device is also relatively slow and tedious to use because each device system and apparatus must be carried and transported from one location to another. This method also requires that the hole be exploded soon after the gas is charged in the burrow because no items are in place to prevent this gas from escaping out of the entry of the burrow.

Therefore, what is needed is a system for effectively killing burrowing animals such as gophers within a burrow, in a way that prevents damage or injury to a user or operator of the device. What is also needed is a device that more efficiently increases the compressive power of the explosion by preventing leakage of gas through the topside of the hole. What is also needed is a device that allows for increased ease and accessibility of a user to move and detonate various varmint holes from a specified location.

Accordingly, it is an object of the present invention to provide a device for effectively killing animals such as gophers through a device that protects the user from the unintended impact from flying debris. Another object of the present invention is to provide a gas powered varmint extermination system that makes more efficient use of gas and provides a more concentrated charge of explosive material to the animals which are to be destroyed.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a device and a method for killing burrowing animals through the remote detonation of an exploding gas within the burrow of an animal. This device requires a source of an exploding gas, preferably propane gas, operatively connected to a mixing tube through a first passageway and a source of oxygen operatively connected to a mixing tube through a second passageway. The mixing tube is operatively connected to a discharge tube by a charging valve. The charging valve is configured to selectively allow passage of mixed gas from the mixing tube through a safety switch along a discharge tube to a head. This safety switch is configured to prevent the flow of electrical current through the unit when pressure within the discharge tube is above a designated threshold. In the preferred embodiment this is above 3 psi.

The discharge tube is operatively connected to a head which has a generally circumvolvingly sloped face portion configured to be inserted within the burrow. The head defines a generally hollow passageway, which transports gas through the head and into the burrow. A flashback arrestor is positioned within the head near the end of the discharge tube. This flashback arrestor prevents the passage of flame or fire through said discharge tube towards the gas or oxygen source.

In use, the gas can be transmitted to the burrow by allowing the gas to pass through the passageways and into the burrow through the head. The various safety features of the device such as the pressure switch and the flashback arrestor prevent the flashback of flame through the gas discharge tube. In some embodiments additional flashback arrestors are positioned along the first and second supply tubes where these first and second supply tubes connect with the mixing tube so as to form a Y shaped configuration. Depending upon the size of the animal and the burrows that are to be treated, the amount of time in which the gas and oxygen mixture is allowed to permeate the burrow may be varied.

Once the burrow is sufficiently filled, the device can be triggered by remote control so as to ignite the gas within the burrow. In the preferred embodiment, the remote control system includes a remote transmitting device which can be held by the operator and which sends the signal to the receiver which is located within a control box near the battery and the master switch. When the signal to ignite the gas is received, this signal travels down a conduit such as a wire or other device which then activates the ignition device which then in turn causes a spark plug to spark. This spark from the spark plug ignites the gas within the burrow, which in turn causes the gas to ignite and explode. This explosion in turn causes a concussion, which kills the animals in the burrow.

The present invention is preferably operated by hoses on retrievable reels which are configured to extend a designated distance from the location where the tank sources exist. After these devices have been used, the reels can be used to recoil the hoses and thus place the hoses back on to reels. Furthermore, the present invention allows for various heads to emanate from a single tank location which can be placed upon a moveable device such as a trailer and moved from one location to another. This configuration allows for a party to pull this trailer through a single space such as a hay field and place the heads within the burrows, fill the burrows and detonate these burrows from a remote location. This presents a substantial advantage over the other devices which exist in the prior art because this embodiment of the invention allows the user to exterminate gophers and other varmints in a way that is not only more safe and less fatiguing to the user but also in a way that is substantially more efficient than the other items and methods which exist in the prior art.

The present invention provides a device, system and method for exterminating burrowing animals in a way that is significantly more efficient and safe than those other methods that exist in the prior art. The present invention featuring a weighted head with a sloped front face, allows for more of the gas to be kept in the burrow thus increasing the efficiency of the product over other products which exist in the prior art. The pressure sensing valve prevents accidental operator discharge while charging the burrow. In addition, the flashback arrestors also prevent flashbacks and undesired gas leakage out of the device. The wireless remote triggering operation of the present invention also provides a system wherein larger quantities of gas can be used and the risk of damage to the operator is reduced because the operator can remove themselves a greater distance from the burrow prior to the triggering of the device and the resulting explosion. The use of a liquid self-leveling epoxy within portions of the device not only provides additional weight to the head so as to help the head to stay within the hole, but also provides an insulating and shock absorbing function to the functioning and interior pieces as well.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS AND PHOTOGRAPHS

FIG. 1 is a plan view of the system of the present invention in a preferred first embodiment.

FIG. 2 is a detailed cut-away view of the control box shown in FIG. 1.

FIG. 3 is a detailed cut-away view of the head shown in FIG. 1.

FIG. 4 is an electrical schematic of the wiring of the device as shown in the present invention.

FIG. 5 is a close up view of the control box and delivery device shown in FIGS. 1-3.

FIG. 6 is a view of the tanks of the present invention and the trailer upon which the device is hauled from one location to another.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

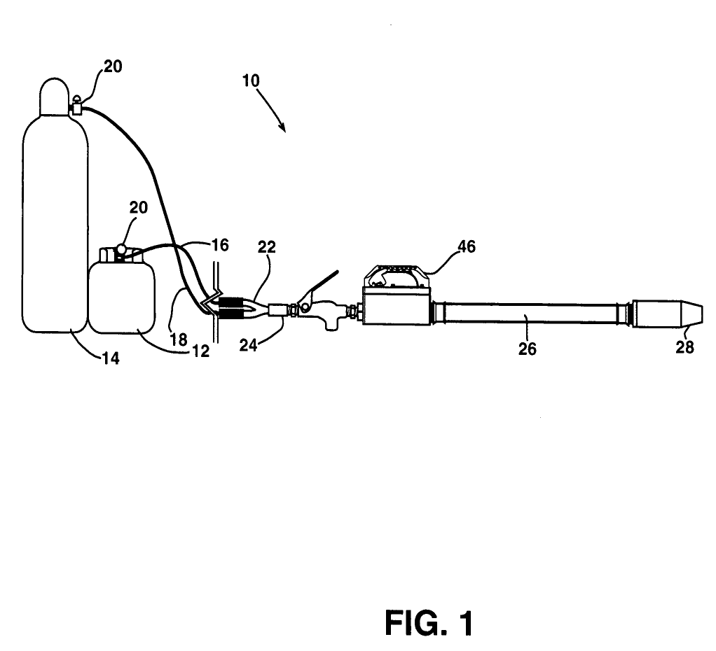

FIGS. 1-6 of the present patent application show a variety of views of the present invention. Referring first now to FIG. 1, a view of one of the preferred embodiments of the present invention is shown. The present invention 10 is made up of a source of propane gas 12, which is operatively connected to a mixing tube 22 through a first passageway 16, 16′. In the preferred embodiment a regulator 20 is connected between the tank and the first passageway 16, 16′. A source of oxygen 14 is connected through a regulator 20 to a second passageway 18, 18′. This passageway is configured to bring gas from the oxygen source 14 into the mixing tube 22. In the preferred embodiment, a valve regulator 20 is positioned along this passageway 18, 18′ between the oxygen tank and the mixing tube 22. In the preferred embodiment this oxygen is stored in a liquid form which is converted to gas prior to exiting the source tank but it is to be distinctly understood that the invention may also utilize gaseous oxygen as well.

A second regulator 20′ is connected between the propane tank and the mixing tube 22. By varying the quantity and amount of oxygen as compared to the quantity of propane gas which is transmitted through the mixing tube, a proper and optimal explosive mixture can be formulated. The ratio of the oxygen to the propane is dependent upon a variety of factors including the ambient temperature, the strength of the propane being used and other factors. The quantity of gas that is transferred into mixing tube 22 is typically regulated through the control valves by varying the pressure of the two devices so as to allow to provide the proper mixing of oxygen and propane. While on the particular demonstration day a mixture of 30 psi of oxygen to 15 psi propane was the best set mixture for blowing these holes, this particular configuration was limited to the other circumstances present on that day. It is to be distinctly understood that this specific disclosure is related solely to the best mode of operating preferred embodiment of the invention on a particular day and is in no way limiting as to the various mixtures which can be utilized with this invention.

As the oxygen and propane are connected and initially mixed in a preferably Y shaped mixing tube 22, these gasses are then fed through this mixing tube 22 through a charging valve 24 into a discharge tube 26. In the preferred embodiment, the mixing tube 22 and the first and second passageways 16, 16′, 18, 18′ are made from one-quarter inch standard gas hose that has been appropriately tested and modified so as to prevent leaks and conformed to the appropriate safety and industrial standards.

In the preferred embodiment this charging valve 24 is a thumb operated charging valve, however, it is to be distinctly understood that a variety of other types of charging valves may also be utilized. In another embodiment of the invention the charging valve is an automatic fuel charge unit. This unit may be either electrically or mechanically operated and allows a user to preset the quantity of time in which the charging valve will be opened. In such an embodiment this would allow an operator to place the head of the device 28 into a burrow to activate the timer to release gas into the burrow. While this device is charging, the operator may then go and place additional heads 28 in other burrows and similarly set the timing devices to activate the flow of gas into those holes. Once these holes have filled with the desired quantity of gas, the charging valve automatically shuts off and the gas in the hole can be ignited by remote control. The various safety features of the present invention prevent the inadvertent ignition of gas when such an explosion is not desired. In addition, the inclusion of a such a timer based charging valve increases the safety to a user as this device allows the user an increased period of time to remove himself from the area in which the device is placed.

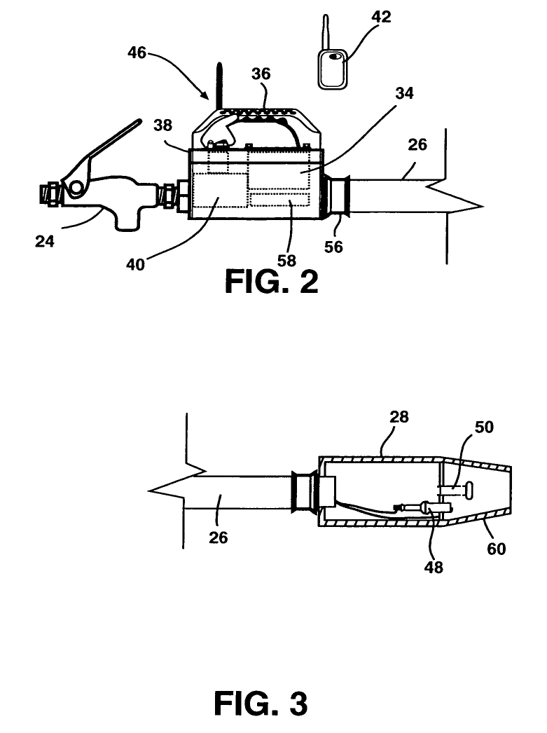

From the charging valve 24, the gas is connected to a discharge tube 26 which extends from the charging valve 24, through the control box 46, to a discharge head 28. As shown in FIG. 2, as the discharge tube 26 passes through the control box 46, the discharge tube 26 passes by a safety pressure switch 44 which is located along the discharge tube 26. This safety pressure switch is configured to stop the flow of current through the discharge tube 26 when the back-pressure upon the valve is approximately 3 pounds or more. When this situation occurs, the safety-pressure switch 24 opens and further passage of current through the device ceases. The purpose of this safety switch 44 is to prevent accidental discharge of the ignition device while the burrow is being filled and fueled with gas.

As the discharge tube 26 continues down through the discharge head 28, a passageway is formed that allows gas to then pass into the discharge head through a flashback arrestor 32 located in the 28 head. Such an embodiment is shown in FIG. 3. At the exit end of the discharge tube 26 an ignition device preferably a spark plug 48 is positioned. As will be described further in detail, this spark plug 48 interacts with a wireless remote electrical ignition system so as to ignite the charged gas in the head 28 and in the burrow so as to cause a concussion sufficient to kill the animals.

Referring now to FIG. 2 a detailed cut-a-way view of the control box 46 shown in FIG. 1 is demonstrated. Control box 46 defines a passageway through which the discharge tube 26 flows. This control box 46 also contains the electrical ignition system and the operating mechanism for this entire device. Within the control box 46 an electrical power source 34 is positioned. In the preferred embodiment this electrical power source is a 12-volt battery having a positive terminal and a negative terminal. In other embodiments, the model of the device is operated by 9-volt disposable batteries and does not contain any recharging system. The battery or electrical power source is configured to transmit and supply power so as to activate the spark plug 48 and initiate the explosion on command. This battery 34 as operatively connected to a charging port 38 as well as a remote receiver 40 through a master control switch 36. This master control switch 36 connects all of the various electrical pieces of the device. Without this control switch 36, the device is inoperable and cannot function.

Referring now to FIG. 3 of the invention. FIG. 3 is a detailed cut-a-way view of the head 28 shown in FIG. 1. The head 28 defines a passageway 26 into which the discharge tube 26 of the device passes. Connected to the discharge tube 26 is a flame suppresser 32 which is connected to one end of the discharge tube 26 and is configured to prevent flame or sparks from passing back along the discharge tube 26 toward the control box 46 and the gas sources 12, 14. The head 28 also comprises an ignition device 48, which is connected by electrical cables back to the control box. This ignition device 48 receives input from the receiver 40 through the electrical cables 56 and excites and ignites the spark plug 48 causing a spark to occur. This spark then ignites the gas which has been previously placed into the burrow and rapidly combusts the gas stored within the burrow and the device so as to cause an explosion sufficient to cause damage and to kill the rodents within the burrow.

In order to achieve a better seal between the gas inputting device and the hole into which the gas is sent, the head 28 has a tapered front face portion 60. This tapered face 60 allows the head 28 to be inserted into the hole at one end of the burrow while also providing sufficient blocking of the hole to contain the impact from the firing of the device within the hole and to enhance the concussive force which results. In the preferred embodiment, the head 28 is made of aircraft-quality aluminum. This enables the material to be sufficiently lightweight so as to be carried and moved easily, while also being able to withstand the temperatures and explosive forces, which are used in the present invention. In the preferred embodiment, the head further comprises a diffuser nozzle 50 located at the end of the discharge tube 26. This diffuser nozzle 50 has a designated shape and is configured to assist in the dispersion of mixed gases and oxygen into the hole in a state, which is more readily available for combustion. In the preferred embodiment, this diffuser nozzle is made up of a stainless steel cap with a plurality of holes that allow for the increased dispersion of the gas through the diff-user nozzle. In the preferred embodiment this head is filled with liquid epoxy which hardens and thus insulates and protects the internal portions which are positioned within the head but also provides sufficient heft and weight to the head so as to prevent the head from being blown out of the hole when the outlined explosion takes place.

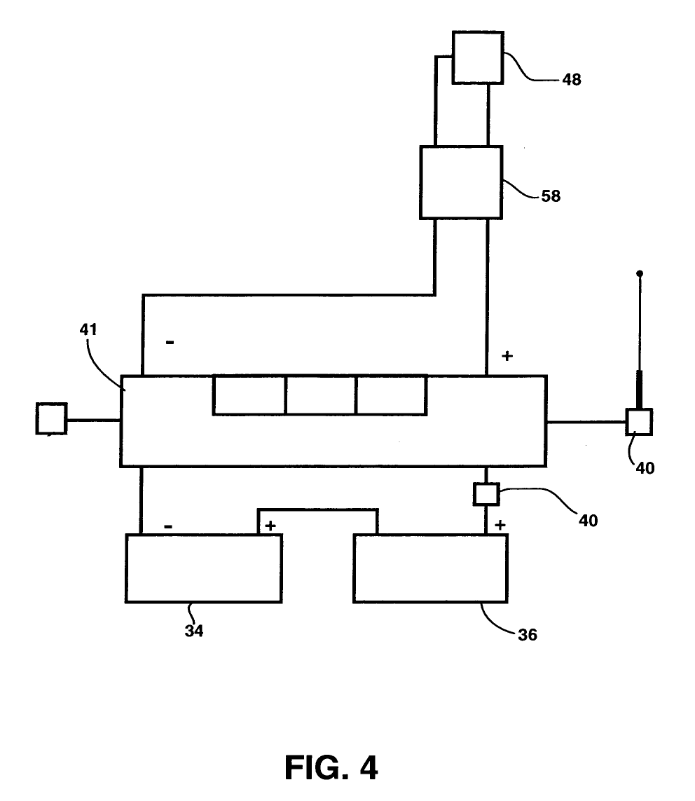

Referring now to FIG. 4, the electrical schematic of the present invention is shown. This feature shows the various electrical connections between the parts of the invention and demonstrates how these parts of the invention work together to produce the spark at the end of the device which is sufficient to cause the explosion within the device to take place. The electrical charge to operate this system is provided by the battery 34. The flow of current from the battery into the other parts of the device is controlled by the master switch 36. This master switch 36 is connected to a wireless remote receiver 41. This receiver 41 is operably connected to an antenna 40, which receives a signal from a wireless remote triggering device 42. Depending upon the exact configuration required by a user the receiver 41 may be modified and configured to allow multiple triggering devices to activate various ignition devices 48. When the receiver 41 receives the command from the remote triggering device 42, the receiver operates an internal switch which then sends power to the step up transformer 58 which then sends a charge to the ignition device 48 which in the preferred embodiment is a sparking plug. When this spark is created the gas within the hole is detonated and animals within the burrow destroyed.

This charging post 38 is charged and recharged by the battery 34 and when activated provides a surge of electricity through the system sufficient so as to ignite the igniter spark plug 48 which in turn ignites the gas in the system. The passive switch 44 acts as a safety feature and prevents the passage of current to the spark plug 48 through this system and prevents accidental discharge of the device while the burrow is being filled.

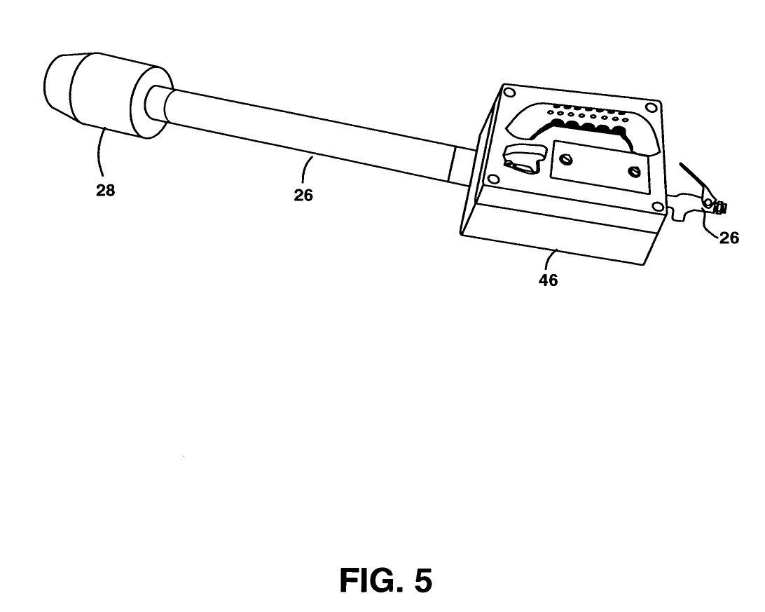

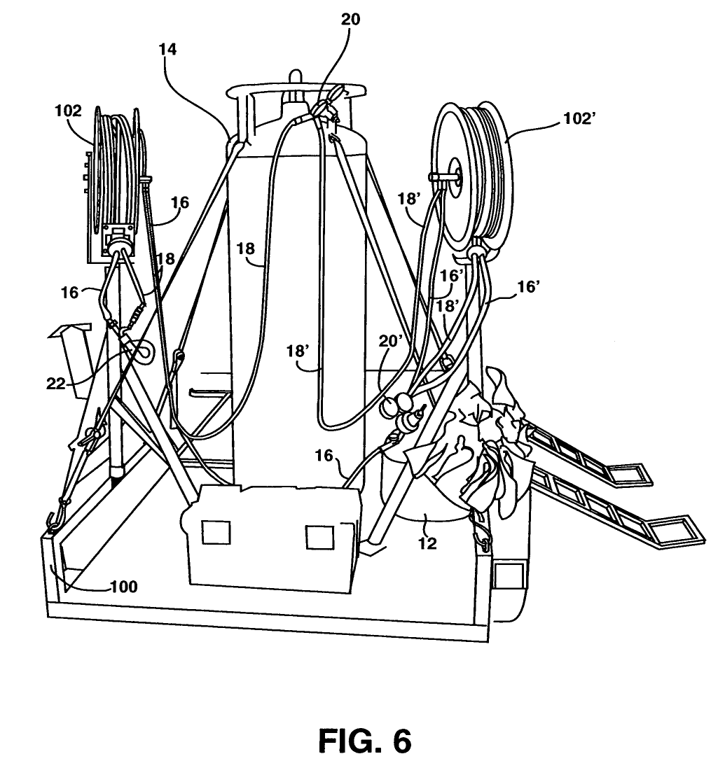

FIG. 5 shows a detailed view of the command box 46, the discharge tube 26 and the head 28 as they exist in the preferred embodiment. FIG. 6 shows a view of the present invention in use upon a trailer 100 as the device is preferably placed and arranged. In the preferred embodiment the gas sources 12, 14 are placed upon a trailer and gas source lines 16, 16′, 18, 18′ are directed from the gas sources 12, 14 through regulators 20, 20′ to mixing tubes 22. These mixing tubes are then connected to discharge tubes 26 which are wound upon reels 102, 102′ placed upon towers upon the trailer itself. These reels allow for the alternative extension and retraction of these discharge tubes 26 from their position upon the reel. In use, these discharge tubes 26 can be unwound from their respective reels and extended a desired distance to where a burrow is located. These discharge tubes can then be connected to the charging valve 24 through a desired connection means. Once connected to the charging valve, the head 28 of the device can be placed within a burrow, the charging valve 24 opened so as to allow the passage of gas through the device and into the burrow. Once the desired quantity of gas has been allowed to pass into the hole, the operator can remove themselves a safe distance from the burrow and activate the wireless activation device 42 so as to cause the gas within the hole to detonate and explode.

Among the advantages offered by the prior art is the fact that the preferred embodiment by having two or in some instances more than two reels attached to the tanks, a user can move various heads from a single position and thus avoid having to carry the gas tanks all over an area such as a field where the device is being used. In addition, the present invention allows the user to be removed from the burrow which is to be detonated thereby reducing the likelihood of injury to the user.

In the preferred embodiment, the trailer 100 upon which the device is stored and pulled contains ramps so as to allow a vehicle such as a four-wheeled motorcycle or small tractor to be placed upon the trailer while the trailer is moved from one location to another by a device such as a pick-up truck. Once the pick-up truck has moved the trailer from one location to another, the tractor or four-wheeled motorcycle or other similar device can be utilized to pull the invention around the field or other area where the burrows are to be destroyed. Such a trailer is also preferably equipped with additional equipment such as flags for indicating the holes that are to be blown or that have been blown as well as other tools such as shovels and other tools which are typically utilized in such an operation.

In the preferred embodiment of the invention, the invention is utilized by a user finding a burrow of an animal which it wishes to remove. Once, this location has been found, the burrow is opened up by removing sufficient quantities of material out of the opening so as to allow insertion of the head into the burrow. The flat-sloped face portion of the head 28 ensures that a greater quantity of gas goes into the hole and less of the gas escapes outward through the rear portions of the hole. In some instances the head 28 of the device may be covered with dirt so as to further retard the flow of gas out of the opening. In addition to the resistive properties that the metals in the head 28 provide, a heavy head 28 also assists to maintain the head in a desired position during the explosive process.

After all the appropriate connections have been made and the head 28 is properly inserted and in place within the burrow, the oxygen and propane are then released through the first 16, 16′ and second 18, 18′ passageways into the mixing passageway 22 in the appropriate desired amounts. This mixed gas is then discharged through the discharge line 26 into the burrow for a designated period of time. For example, a typical gopher hole may require that the gas and oxygen mixture be placed into the burrow for a period of 30-60 seconds. Other types of animals may require other periods of time. These times are also dependent upon the ambient conditions in which the device is used which may be affected by variations such as pressure and temperature variations.

After the head 28 is in place in the hole and the hole has been charged, the operator can then remove himself or herself a significant distance from the hole and remotely activate the device by sending a signal from the hand-held wireless remote transmitter 42. The signal from this transmitter then goes to the remote receiver 40, which is charged by the battery 34 in the charging port 38. This signal is then sent from the receiver down the cable 56 to the ignition switch device 58. This ignition switch 58 then sends a signal to the sparkplug 48 which ignites a spark causing an explosion to cause a concussion which is designed to kill the animals and rodents within the den.

This device provides a significant advantage over the other devices, which exist in the prior art. For example, the present invention prevents damage to a user by allowing the distance between the user who detonates the explosive device and the location where the explosion takes place to be significant. This greatly enhances the safety to the user. Another advantage of the present invention is that the shape of the head allows for more efficient use of the gas within the burrow while preventing the unintended escape of gas out of the burrow. This enables the compressive and explosive power of the device to be concentrated in a specific location within the hole itself.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A device for killing burrowing animals comprising:
a source of propane gas connected to a mixing tube through a first passageway,
a source of oxygen connected to a mixing tube through a second passageway,
said mixing tube operatively connected to said first passageway and said second passageway, said mixing tube operatively connected to a discharge tube by a charging valve;
said charging valve configured to selectively allow passage of mixed gas from said mixing tube through a discharge tube to a weighted head;
a safety switch configured to prevent the flow of current through said unit when pressure within said discharge tube is below a designated threshold;
a flashback arrestor located within said weighted head, said flashback arrestor configured to prevent the passage of flame or fire through said discharge tube toward said gas source;
a wireless remote ignition system comprising a wireless remote transmitter configured to interact with a wireless remote receiver to trigger a spark sufficient to cause a spark to ignite said mixed gas within said burrow.

2. The device for killing burrowing animals of claim 1 wherein said weighted head further comprises a diffuser nozzle connected to said discharge tube, said diffuser nozzle defining a plurality of passageways therein, said diffuser nozzle configured to allow for the proper dispersal and mixture of said propane gas and said oxygen gas within a burrow.

3. The device for killing burrowing animals of claim 1 further comprising an ignition override switch, said ignition override switch configured to prevent the accidental ignition of gasses from said discharge tube when said device is being charged.

4. The device for killing burrowing animals of claim 1 wherein said charging valve is an automatic charging valve that operates with a timer to automatically stop the flow of gas through said unit upon the passage of a designated period of time.

5. The device for killing burrowing animals of claim 1 further comprising:
an ignition override valve, said ignition over ride valve configured to prevent discharge of gasses while said charging valve is open.

6. The device for killing burrowing animals of claim 1 further comprising:
an anti-flashback valve, said anti-flash back valve configured to prevent passage of flame from said discharge tube back toward said source.

7. The device for killing burrowing animals of claim 1 wherein said weighted head has a generally circumvolvingly sloped face portion configured for insertion into the burrow of an animal, said head defining a generally hollow passageway, said passageway configured to allow the passage of mixed gas from said discharge head into said burrow.

8. A device for killing burrowing animals comprising:
a source of flammable gas connected to a mixing tube through a first passageway,
a source of oxygen connected to a mixing tube through a second passageway,
said mixing tube operatively connected to said first passageway and said second passageway; said mixing tube operatively connected to a flexible discharge tube by a charging valve;
said charging valve configured to selectively allow passage of mixed gas from said mixing tube through said discharge tube to a weighted head connected to said flexible discharge tube;
said weighted head having a generally cylindrically shaped body and a frustoconically shaped generally sloping front face portion and defining a discharge passageway therethrough, said head configured to be placed within a burrow said head further having sufficient weight so as to remain within said burrow when a quantity of gas within said burrow is detonated and a control box positioned between said head and said mixing tube said control box further comprising, a portion of a wireless remote ignition device configured to detonate said gas from a user in a remote location and said charging valve.

9. The device of claim 8 wherein said weighted head further comprises an ignition device located within said weighted head, said ignition device configured to ignite said mixed gas.

10. The device of claim 9 wherein said weighted head further comprises a quantity of an epoxy filler.

11. (canceled)

12. The device of claim 10 wherein said weighted head comprises:
a safety switch configured to prevent the flow of current through said unit when pressure within said discharge tube is below a designated threshold;
a flashback arrestor located within said head, said flashback arrestor configured to prevent the passage of flame or fire through said discharge tube toward said gas source;
a wireless remote ignition system comprised of a wireless receiver, and a remote transmitter configured to interact with said receiver of said remote ignition system so as to cause a spark to ignite said mixed gas within said burrow; and
a diffuser nozzle connected to said discharge tube, said diffuser nozzle defining a plurality of passageways therein, said diffuser nozzle configured to allow for the proper dispersal and mixture of said propane gas and said oxygen gas within a burrow.

13. A method for killing burrowing animals in their burrow comprising the steps of:
opening a burrow,
inserting the tip of a discharge tube into said burrow,
charging said burrow with a designated quantity of a mixture of the propane and oxygen gas,
igniting the gas within said burrow by a wireless remote control device.

14. The method of claim 13 wherein said step of charging said burrow further comprises adding sufficient propane and oxygen gas into said burrow through a timer switch.

15. The method of claim 13 wherein said step of remotely igniting said gas within said burrow includes the use of a remote wireless device to activate the explosion of gas within that opening.

16. The device for killing burrowing animals of claim 10 wherein said control box further comprises an ignition override switch, said ignition override switch configured to prevent the accidental ignition of gasses from said discharge tube when said device is being charged.

17. The device for killing burrowing animals of claim 10 wherein said charging valve is an automatic charging valve that operates with a timer to automatically stop the flow of gas through said unit upon the passage of a designated period of time.
